(19) United States
(12) Patent Application Publication
(10) Pub. No.: US 2015/0047236 A1
(43) Pub. Date: Feb. 19, 2015

(54) STATUS-INDICATING DEVICE

(71) Applicants: Patrick Hamel, Waterbury, CT (US); Cornelio Crespo, Waterbury, CT (US); Ricky Crespo, Thomaston, CT (US)

(72) Inventors: Patrick Hamel, Waterbury, CT (US); Cornelio Crespo, Waterbury, CT (US); Ricky Crespo, Thomaston, CT (US)

(21) Appl. No.: 14/461,676

(22) Filed: Aug. 18, 2014

Related U.S. Application Data
(60) Provisional application No. 61/866,613, filed on Aug. 16, 2013.

(51) Int. Cl. G09F 11/00

(52) U.S. Cl. CPC G09F 11/00
USPC 40/491

(57) ABSTRACT

A status-indicating device configured to be mounted over a window in a door. The status-indicating device having a substantially rectangular frame and a first panel and a second panel slidably supported in the frame. The first panel has a first status indicia and the second panel has a second status indicia different than the first status indicia. The first panel and second panel are configured to move between a first position that does not completely obstruct the window and a second position that completely obstructs the window.

### CROSS REFERENCE TO RELATED APPLICATION

This application claims the benefit of U.S. Provisional Application No. 61/866,613 filed Aug. 16, 2013.

### BACKGROUND

There has been a dramatic increase in mass shootings in recent years, particularly in school settings. It appears that shooters have taken advantage of restrictions on firearms in educational institutions, where many unarmed and innocent people gather on a daily set schedule. School settings have many security vulnerabilities, which armed intruders can exploit to have access to a large congregation of people with limited means to protect themselves.

When trying to determine improvements in school security to ensure the safety of schoolchildren and school staff, one of the most important considerations is the security of the individual classrooms. In the majority of school settings, each classroom has two doors for entering and exiting the room, and each of those doors has a window looking into the classroom. Virtually all school districts are mandated to have windows in their classroom doors, free of any obstruction so as to provide a clear view into the classroom from outside the classroom.

While having an unobstructed view into a classroom is not problematic during normal school operations, it can be a security vulnerability during an emergency situation involving an armed intruder, because the door windows provide an intruder visual access to occupants in the classroom. With the increase of school shootings in recent years, several major issues have become apparent when addressing the problem of school intruders. Two of these issues are: 1) securing all occupants in the school to make them as inaccessible to the intruder as possible; and 2) giving as much information as possible to law enforcement officers as they enter the school to ensure a quick response to areas of the school targeted by the intruder.

### SUMMARY

Provided is a device that is easy to operate during an emergency situation to obstruct the view through a door window and to indicate the status of the occupants in the room. The device is also adapted to provide an unobstructed view through the door window during normal non-emergency conditions. The device is configured to be fixed to the inside of a door over a window in the door so that the device is in position to operate during an emergency situation.

In one embodiment, a status-indicating device configured to be mounted over a window in a door, comprises a substantially rectangular frame, a first panel and a second panel slidably supported in the frame, the first panel having a first status indicia and the second panel having a second status indicia, where each of the first panel and second panel is configured to move between a first position that does not completely obstruct the window and a second position that completely obstructs the window. In other embodiments, the status-indicating device may comprise more than two panels. For example, additional panels with additional status indicia may be included.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific embodiments disclosed. In the drawings:

FIGS. 1-4 show different views of an exemplary status-indicating device;

FIG. 5 shows an exemplary door with a window;

FIG. 6 shows the exemplary status-indicating device in a first working position;

FIG. 7 shows the exemplary status-indicating device mounted to a door in a first working position;

FIG. 8 shows the exemplary status-indicating device in a second working position;

FIG. 9 shows the exemplary status-indicating device mounted to a door in a second working position;

FIG. 10 shows the exemplary status-indicating device in a second working position; and

FIG. 11 shows the exemplary status-indicating device mounted to a door in a second working position.

### DETAILED DESCRIPTION

Before the various embodiments are described in further detail, it is to be understood that the invention is not limited to the particular embodiments described. It is also to be understood that the terminology used is for the purpose of describing particular embodiments only, and is not intended to limit the scope of the claims of the present application.

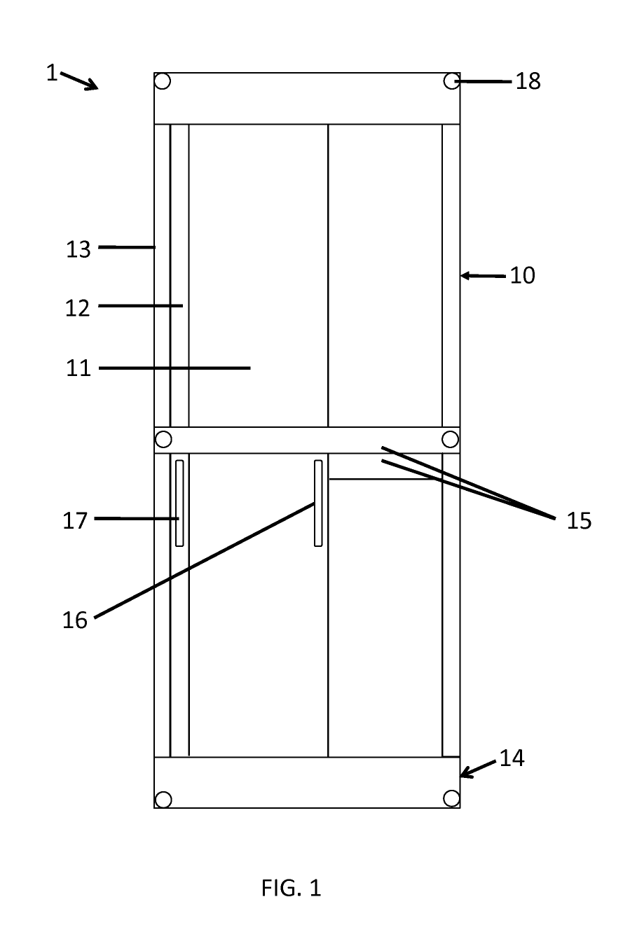

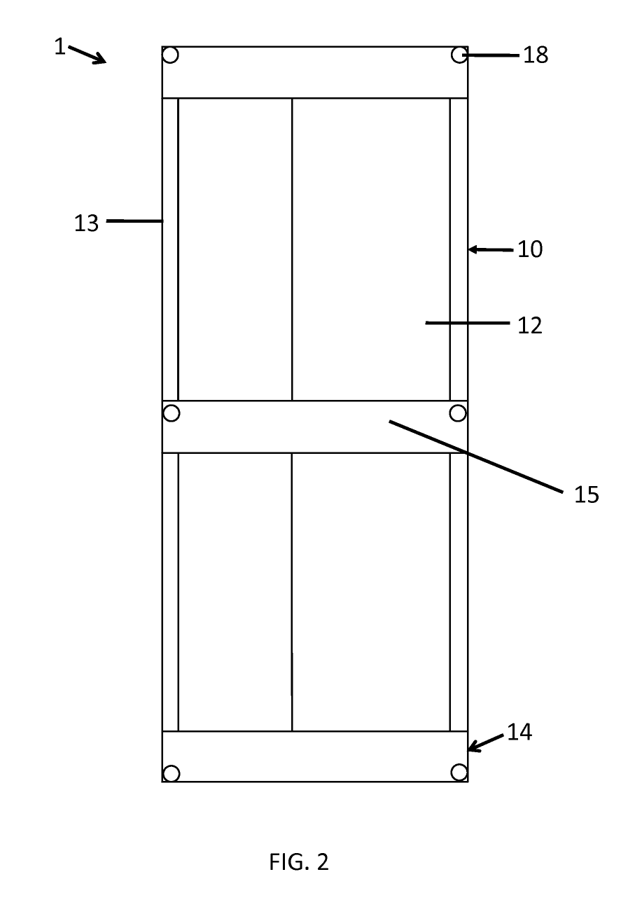

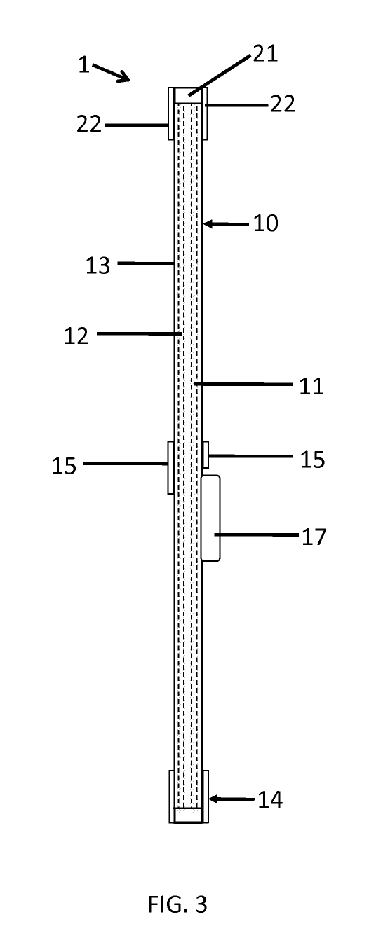

Provided is a status-indicating device 1 configured to be fixedly mounted on a door 2 over a window 20 in the door 2. As shown in FIGS. 1-3, the status-indicating device 1 may comprise a frame 10 and a first panel 11 and second panel 12 slidably mounted on the frame 10. FIG. 1 shows a front view of the status-indicating device 1 (i.e., the side of the device facing the room). Figure shows a back view of the status-indicating device 1 (i.e., the side of the device abutting the door when installed). FIG. 3 shows a side view of the status-indicating device 1.

The frame 10 is configured to be mounted on a door 2 around a window 20. Further, the frame 10 is configured to slidably support a first panel 11 and second panel 12 so that they can be moved between a position where they do not obstruct the window 20 and a position where they completely obstruct the window 20. The first panel 11 and second panel 12 are each sized to have a width that is smaller than the width of the frame 10, such that the first panel 11 and second panel 12 can be moved to one side of the frame 10 to create an opening in the frame 10 in order to provide a view through a window in a door. Further, the first panel 11 and second panel 12 are sized such that the first panel 11 and second panel 12 can be moved to completely obstruct the view through the window in the door. In some embodiments, the status-indicating device may comprise more than two panels. For example, additional panels with additional status indicia may be included.

As shown, the frame 10 may be substantially rectangular and may comprise two vertically-spanning members 13 and two horizontally-spanning members 14. One or both of the two horizontally-spanning members 14 may include a channel running along the length of the horizontally-spanning member 14, which is adapted to receive an edge of the first panel 11 and an edge of the second panel 12 so that the panels 11, 12 can be slidably supported in the frame 10. In one embodiment, the horizontally-spanning member 14 may be constructed by sandwiching a rail 21 between two plates 22. The rail 21 and plates 22 may have the same width, but the plates 22 preferably have greater height such that a channel is created between the plates 22 in which to receive the panels 11, 12. The width of the frame 10 (i.e., the length of the horizontally-spanning members 14) is adapted to allow the first panel 11 and second panel 12 to be moved to between a position where they do not obstruct the window 20 and a position where they completely obstruct the window 20.

In one embodiment, the horizontally-spanning members 14 may have an adjustable length for adapting the device 1 to be used with door windows of varying widths. For instance a horizontally-spanning member 14 may be made of two separate members that slidably engage each other so that the length of the horizontally-spanning member 14 can be adjusted. Additionally, the frame 10 may further comprise one or more stiffening braces 15 extending across a horizontal span and being attached to the two vertically-spanning members 13. Also, in some embodiments, the vertically-spanning members 13 may have an adjustable length for adapting the device 1 to be used with door windows of varying heights. For instance a vertically-spanning member 13 may be made of two separate members that slidably engage each other so that the length of the vertically-spanning member 13 can be adjusted.

Some or all of the components of the frame 10 may be integrally formed as one piece, for example, by a process such as molding or casting. Alternatively, each of the components of the frame 10 may be provided separately and assembled together. The frame 10 may be made of a clear, transparent acrylic material. The frame 10, however, may be made of any suitable material, including plastic, wood, metal, etc. The frame 10 is configured to be mounted on a door 2 around a window 20 with fastening means 18. Fastening means 18 may be any conventional fasteners, such as screws for example. Spacers may be used between the frame 10 and door 2 if needed to provide clearance for any protruding element on the door, such as a window trim for example.

As shown in FIGS. 1-3, the first panel 11 and second panel 12 are mounted in the frame parallel to each other so that one panel is in front of the other. As shown, the first panel 11 is in front adjacent to the side of the device 1 facing the room and the second panel 12 is in back adjacent to the side of the device 1 abutting the door when installed. The first panel 11 preferably has a handle 16 disposed adjacent to a vertical edge on the front side of the first panel 11 facing the room. The second panel preferably has a handle 17 disposed adjacent to a vertical edge on the front side of the second panel 12 facing the room. The second panel 12 in the back has a slightly larger width than the first panel 11 in the front so that the handle 17 is still accessible even when the first panel 11 is directly in front of the second panel 12.

The first panel 11 includes a first indicia corresponding to a first status signal on the backside of the first panel facing the door. For example, the first panel 11 may be the color green corresponding to a status signal indicating a “safe/ok” status within the room. This “safe/ok” status gives law enforcement officers an indication that all room occupants are safe and accounted for within that room. The second panel 12 includes a second indicia corresponding to a second status signal, which is different than the first status signal, on the backside of the second panel facing the door. For example, the second panel 12 may be the color red corresponding to a status signal indicating a “unsafe/emergency” status within the room. This “unsafe/emergency” status gives law enforcement officers an indication that there is a problem within the room (e.g., unaccounted occupants, medical emergency, etc.). In other embodiments, the status-indicating device may comprise more than two panels 11, 12. Additional panels with additional status indicia may be included. For example, a third panel that is colored yellow may be included to indicate a “potential problem” that does not arise to the level of an “unsafe/emergency” status indicated by the color red.

The first panel 11 and second panel 12 are each sized to have a width that is smaller than the width of the frame 10, such that the first panel 11 and second panel 12 can be moved to one side of the frame 10 to create an opening in the frame 10 in order to provide a view through a window in a door. Further, the first panel 11 and second panel 12 are sized such that the first panel 11 and second panel 12 can be moved to completely obstruct the view through the window in the door. The panels 11, 12 may be made of a translucent or opaque material, such as acrylic for example, but possibly of other suitable materials. Each of the panels 11, 12 is slidably mounted in the frame 10 so that they can be moved into a position obstructing the window 20. Accordingly, when one of the panels 11, 12 is moved into a position obstructing the window the status indicia on the panel is visible through the window 20.

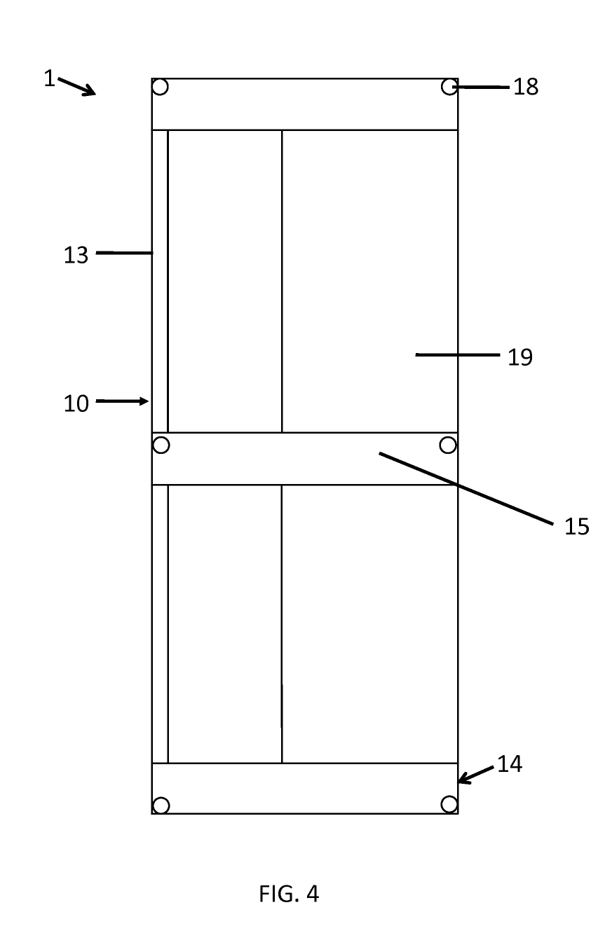

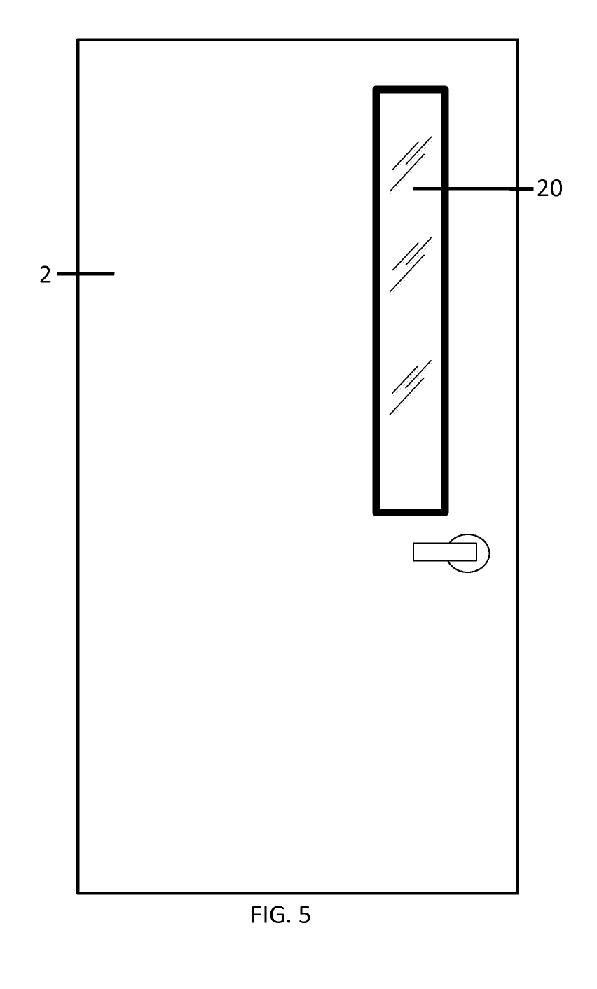

As shown in FIG. 4, the status-indicating device 1 may further comprise a cover panel 19 that is fixedly secured to the frame 10. The cover panel 19 does not have any indicia corresponding to a status signal. For example, the cover panel may be an opaque white color. Further, the cover panel 19 is dimensioned such that it can obscure the first and second panels 11, 12 when viewed through the window from outside the room. Because the status-indicating device 1 may be used to retrofit existing doors, it may be possible to configure the status-indicating device 1 for use with door windows of various dimensions. In some instances, the panels 11, 12 may partially obstruct the window 20 even when moved into the non-obstructing position. Accordingly, the cover panel 19 would serve to obscure any status indicia that may be visible through the window when the panels 11, 12 are moved into the non-obstructing position.

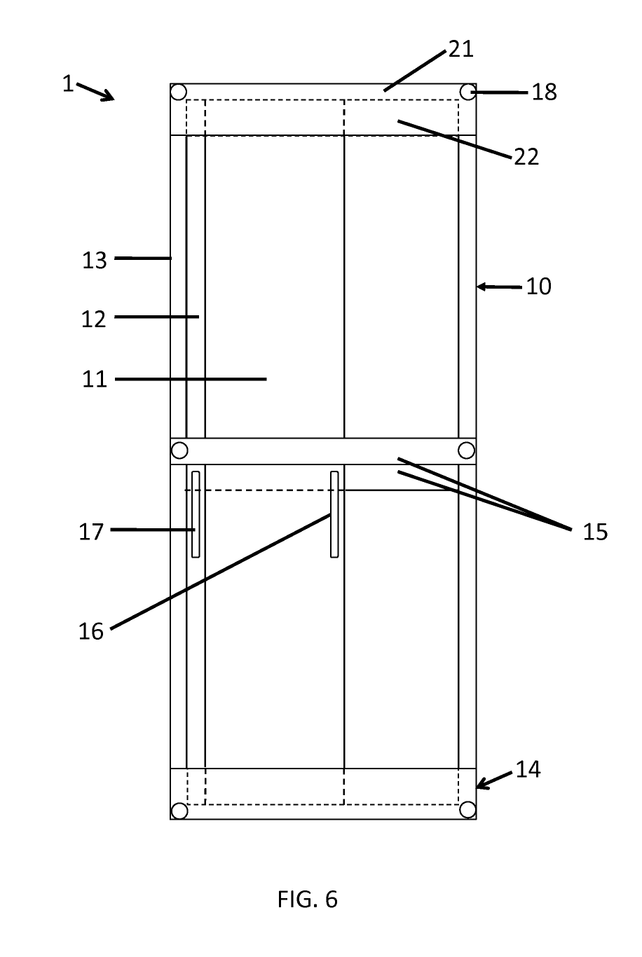

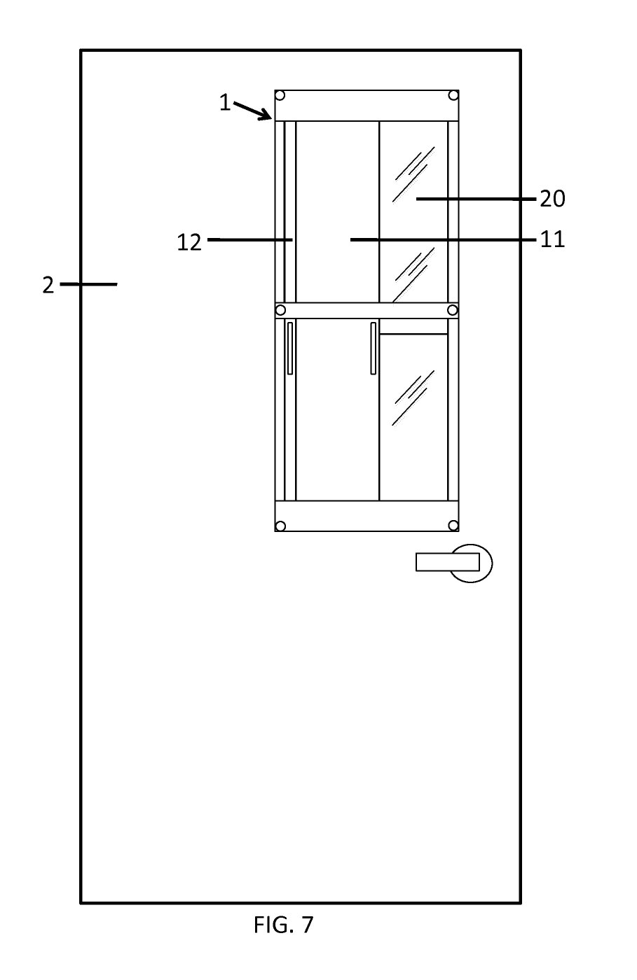

FIG. 6 shows the status-indicating device 1 in a first working position. In this first working position, both of the panels 11, 12 are in a position where they do not obstruct the window. Accordingly, in this first working position, the status-indicating device 1 allows an unobstructed view into the classroom through the window 20. As shown, the width of the frame can accommodate the entire width of the panels 11, 12 while still providing a gap in the frame 10 of sufficient width to provide an unobstructed view through the window 20. FIG. 7 shows the status-indicating device 1 mounted on a door 2 and in the first working position.

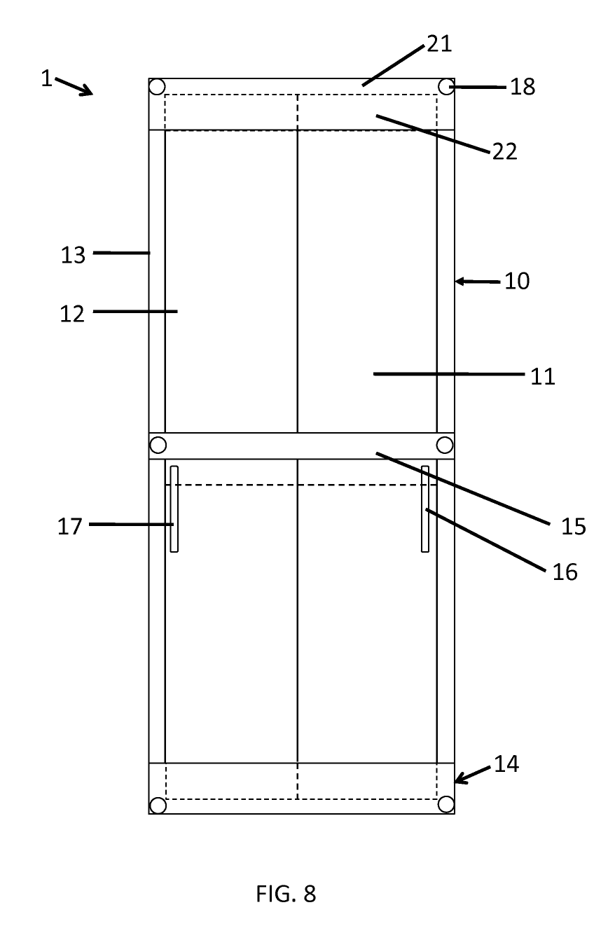

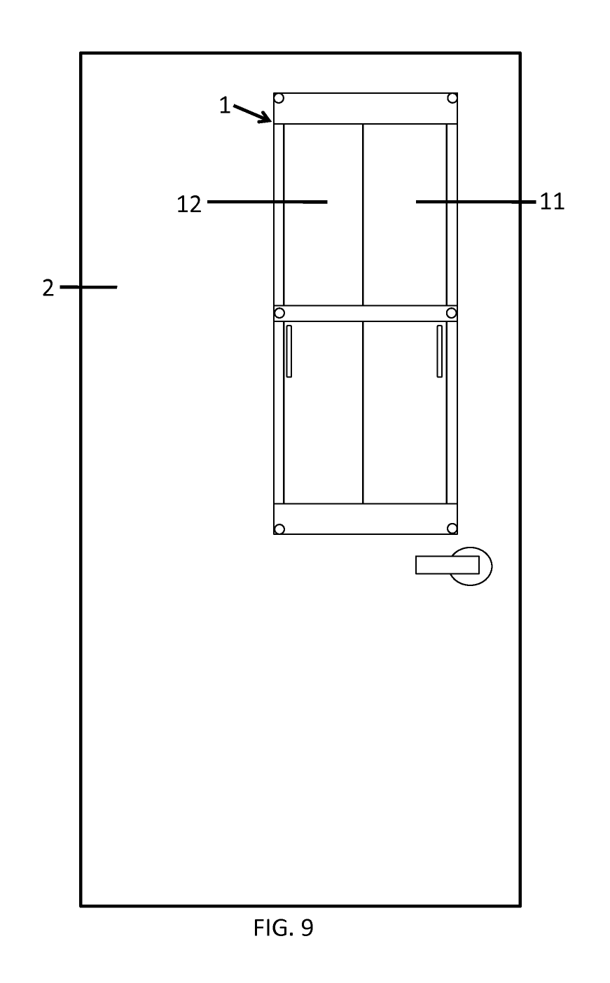

FIG. 8 shows the status-indicating device 1 in a second working position. In this second working position, the first panel 11 is in a position obstructing the window 20. Accordingly, in this second working position, the first indicia on the first panel 11 corresponding to the first status signal are visible through the window 20. FIG. 9 shows the status-indicating device 1 mounted on a door 2 and in the second working position.

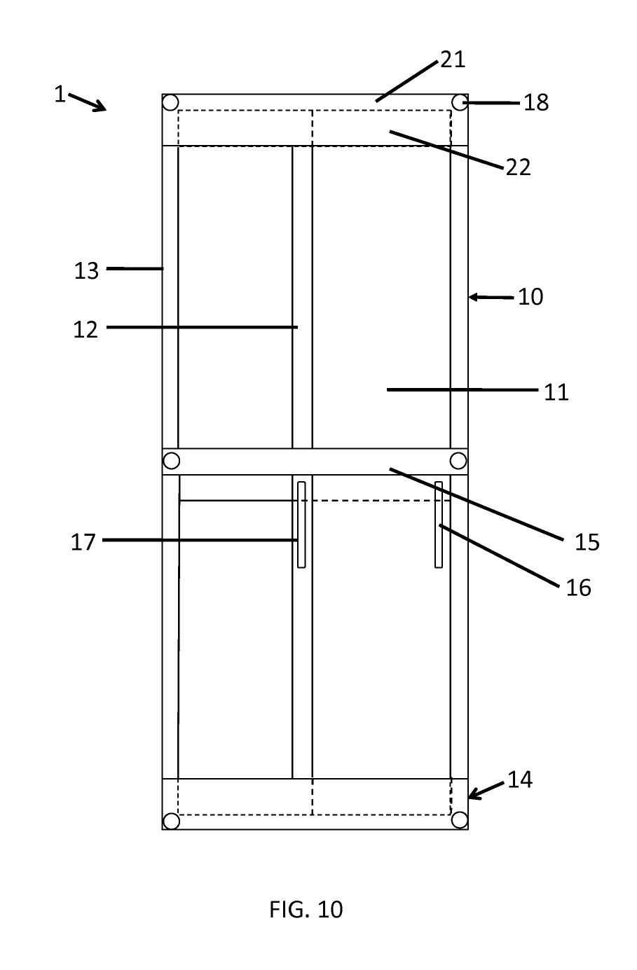

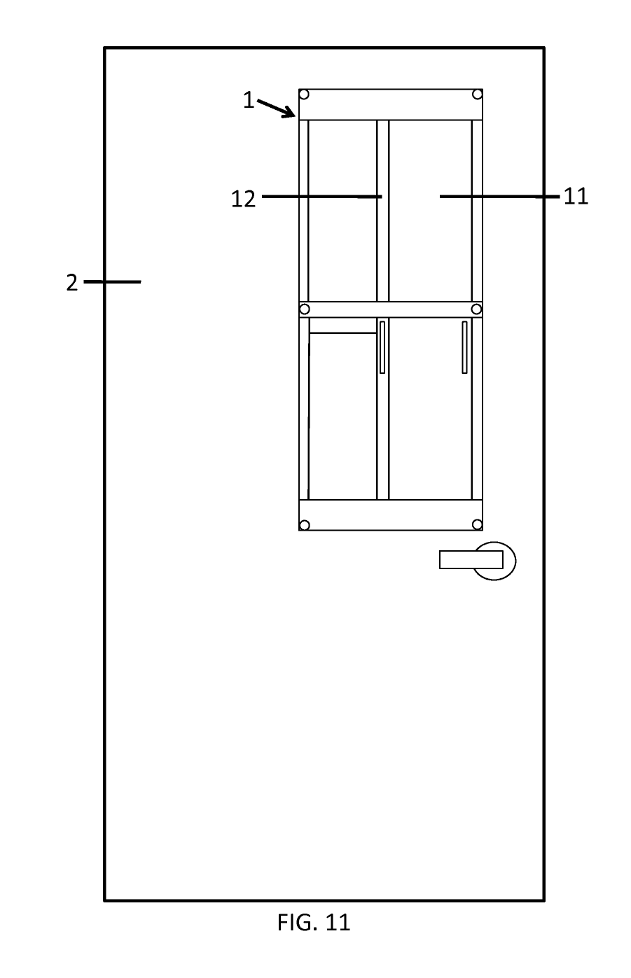

FIG. 10 shows the status-indicating device 1 in a third working position. In this third working position, the second panel 12 is in a position obstructing the window 20. Accordingly, in this third working position, the second indicia on the second panel 12 corresponding to the second status signal are visible through the window 20. FIG. 11 shows the status-indicating device 1 mounted on a door 2 and in the third working position. In the embodiment shown in FIGS. 10-11, the handle 17 of the second panel 12, which sits directly behind the first panel 11, pushes both the first panel 11 and the second panel 12 over the window 20.

The status-indicating device 1 allows law enforcement officers to quickly scan door windows from a hallway during a lock-down scenario to determine if the rooms in the area are safe and secure or if they are in need of assistance. Thus, law enforcement officers can swiftly identify the areas in need of assistance. Further, the status-indicating device 1 prevents an intruder from looking into the room through the door windows. Thus, during a lock-down scenario, the status-indicating device 1 obstructs an intruder's view into a room and prevents the intruder from ascertaining whether the room is occupied or who occupies the room.

While various embodiments have been described, it will be appreciated by those of ordinary skill in the art that modifications can be made to the various embodiments without departing from the spirit and scope of the invention as a whole.

What is claimed is:

1. A status indicating device configured to be mounted over a window in a door, comprising:
a frame sized and configured to be mounted over the window in the door;
a first panel slidably supported on the frame to move horizontally along the width of the frame;
a second panel slidably supported on the frame to move horizontally along the width of the frame;
wherein the first panel and second panel comprise a first status indicia and a second status indicia, respectively, that are different;
wherein the frame, the first panel and the second panel are sized such that the first panel and second panel can be moved to create an opening in the frame in order to provide a view through the window in the door; and
wherein the first panel and second panel are each sized to completely obstruct the view through the window in the door.

2. The status indicating device according to claim 1, wherein the first status indicia is the color red.

3. The status indicating device according to claim 1, wherein the second status indicia is the color green.

4. The status indicating device according to claim 1 further comprising a third panel slidably supported on the frame to move horizontally along the width of the frame, the third panel comprising a third status indicia that is different than the first status indicia and the second status indicia.

5. The status indicating device according to claim 4, wherein the third status indicia is the color yellow.

6. The status indicating device according to claim 1, wherein the frame is made of a transparent material.

7. The status indicating device according to claim 1, wherein the first panel and second panel are made of an opaque or translucent material that can obstruct visibility through the window in the door.

8. The status indicating device according to claim 1, wherein the first panel and second panel are disposed parallel to each other in a channel in the frame.

9. The status indicating device according to claim 1, wherein the frame is configured to have an adjustable width to accommodate door windows of various width dimensions.

10. The status indicating device according to claim 1, wherein the frame is configured to have an adjustable height to accommodate door windows of various height dimensions.

11. A status indicating device configured to be mounted over a window in a door, comprising:
a frame sized and configured to be mounted over the window in the door;
a first panel slidably supported on the frame to move horizontally along the width of the frame;
a second panel slidably supported on the frame to move horizontally along the width of the frame;
a cover panel fixed on the frame, the cover panel covering only a portion of the width of the frame such that an opening is created in the area of the frame not covered by the cover panel, the opening in the frame providing a view through the window in the door;
wherein the first panel and second panel comprise a first status indicia and a second status indicia, respectively, that are different;
wherein the first panel and the second panel are sized smaller than the cover panel such that the first panel and second panel can be moved behind the cover panel and completely blocked by the cover panel; and
wherein the first panel and second panel are each sized to completely obstruct the opening in the frame to block the view through the window in the door.

12. The status indicating device according to claim 11, wherein the first status indicia is the color red.

13. The status indicating device according to claim 11, wherein the second status indicia is the color green.

14. The status indicating device according to claim 11 further comprising a third panel slidably supported on the frame to move horizontally along the width of the frame, the third panel comprising a third status indicia that is different than the first status indicia and the second status indicia.

15. The status indicating device according to claim 14, wherein the third status indicia is the color yellow.

16. The status indicating device according to claim 11, wherein the frame is made of a transparent material.

17. The status indicating device according to claim 11, wherein the first panel, second panel and cover panel are made of an opaque or translucent material that can obstruct visibility through the window in the door.

18. The status indicating device according to claim 11, wherein the cover panel has an opaque white color.

19. The status indicating device according to claim 11 further comprising a third panel slidably supported on the frame to move horizontally along the width of the frame, the third panel comprising a third status indicia that is different than the first status indicia and the second status indicia.

20. The status indicating device according to claim 19, wherein the third status indicia is the color yellow.
